(19) United States
(12) Patent Application Publication
(10) Pub. No.: US 2026/0318370 A1
(43) Pub. Date: Oct. 15, 2026

(54) DOUBLE ACTING DRUM BRAKE WITH BRAKE SHOE LINING ENGAGING WITH THE OUTER AND INNER DRUM SURFACE AT THE SAME TIME

(71) Applicant: Michal KRISLO, Praha 4 - Ujezd u Pruhonic (CZ)

(72) Inventors: Michal KRISLO, Praha 4 - Ujezd u Pruhonic (CZ); Rafael KNOBLOCH, Praha 9 - Letnany (CZ)

(73) Assignee: Michal KRISLO, Praha 4 - Ujezd u Pruhonic (CZ)

(21) Appl. No.: 19/484,643

(22) PCT Filed: Mar. 27, 2024
(86) PCT No.: PCT/CZ2024/050019

§ 371 Date: Nov. 14, 2025

(30) Foreign Application Priority Data
May 22, 2023 (CZ) PUV 2023-40997

(51) Int. Cl. F16D 53/00; F16D 65/22; F16D 121/04; F16D 125/64

(52) U.S. Cl. CPC F16D 53/00; F16D 65/22; F16D 2121/04; F16D 2125/64

(57) ABSTRACT

Double acting drum brake with brake shoe lining engaging simultaneously with the outer and inner surface of the drum (1) with two pairs of brake shoes having each inner brake shoe (3) with inner brake shoe lining (13) and outer brake shoe (2) with outer brake shoe lining (12) is according to the invention characterised in that to each of both pairs of brake shoes is connected a set (4, 4′) of levers in a mirroring way, each consisting of a first class one lever (14), whose pivot point (15) of the first class one lever is fixedly connected with a stationary part of braked device, and second class one lever (16), whose pivot point (17) of the second class one lever is also fixedly connected with a stationary part of braked device, wherein the end of the longer arm of the first class one lever (14) is using a sliding-pivoting hinge connected with the end of the longer arm of the second class one lever (16), wherein the first class one lever (14) is at its shorter arm using a first outer pin (18), located spaced from the pivot point (15) of the first class one lever, pivotally connected with the first end of outer brake shoe (2), and at the opposite side from the pivot point (15) of the first class one lever, then where the first outer pin (18) is, it is, using a first inner pin (19), pivotally connected with the first end of the inner brake shoe (3), wherein the second class one lever (16) is at its shorter arm using a second outer pin (20), located spaced from the pivot point (17) of the second class one lever, pivotally connected with the second end of outer brake shoe (2) and at the other side from the pivot point (17) of the second class one lever, then where the second outer pin (20) is, it is, using a second inner pin (21), pivotally connected to the other end of the inner brake shoes (3), wherein in the space between mutually mirroring arranged sets (4, 4′) of levers, the brake cylinder (6) is arranged as fixedly connected with stationary part of the braked device, which has two actuators (5) expandable in opposite directions, for expanding acting on the first class one lever (14) of each of both sets (4, 4′) of levers always in the place between the first inner pin (19) and the end of the longer arm of the first class one lever (14), and wherein in the space between mutually mirroring arranged sets (4, 4′) of levers is arranged a return spring (24) for mutual pulling the second class one levers (16) of both sets (4, 4′) of levers, attached always in place between the second inner pin (20) and the end of the longer arm of the second first class lever (16).

### BACKGROUND OF THE INVENTION

This invention concerns a drum brake for braking rotating devices, e.g. motorcycle or automobile wheels or machine shafts, which has two pairs of brake shoes, wherein each of both pairs of brake shoes consists always of inner brake shoe with inner brake shoe lining, which is pushed onto the inner drum surface when braking, and outer brake shoe with outer brake shoe lining, which is pushed onto the outer drum surface when braking.

### DESCRIPTION OF THE PRIOR ART

From the patent document GB 10 20 215 is known a drum brake with brake shoes engaging with outer and inner cylindrical surface of the drum at the same time, stowed in brake calliper, which is axially oriented for this purpose. Outer friction lining engaging with outer friction surface of the drum is fastened on one side of the brake calliper, which is welded on one end of a lever, whose second end is rotatably using a pin, installed in stationary plate, and inner friction lining, engaging with inner friction surface of the drum, is controlled by a mechanism consisting of a piston and a cylinder, stowed on the other side of brake calliper. During the activation of the piston, the inner friction lining is pushed onto the inner friction surface of the drum and it is carried in the direction of movement of the drum, which causes the self-locking effect via rotation of the lever carrying the brake calliper. This solution tends to cause uneven wear on brake linings.

Drum brake with a pair of friction linings, arranged on radially opposite drum surfaces, which are engaged together with outer and inner surface of the drum, is known from the patent document GB 11 37 062. Also, this drum brake has a calliper, which is rotatably installed, wherein during piston activation, inner friction lining is pushed to inner friction surface of the drum and it is carried in the direction of movement of the drum, which causes the self-locking effect. An automatic adjusting mechanism is arranged on the lever carrying the calliper, but this doesn't sufficiently solve the uneven wear of brake linings.

From the patent document GB 343 437 is known a drum brake with two pairs of brake shoes, engaging at the same time always with outer and inner surface of the drum. Each of both pairs of brake shoes consists always from inner brake shoe, which is pushed on one end onto the inner surface of the drum using a hydraulic piston, and outer brake shoe, which is at one end pushed onto the outer surface of the drum using second hydraulic piston via rotatably fastened lever. Both inner brake shoe and outer brake shoe of both pairs of brake shoes are rotatably anchored on the second end, which means that always only one of the inner brake shoes and only one of the outer brake shoes is lead-in. The brake according to this document is thus single acting.

From the document U.S. Pat. No. 2,015,083 532 is known an arrangement of cooling of a drum brake, which has braking surface on the inner side of the drum, using ribs on the outer surface of the drum. This solution could not be used for a drum brake engaging at the same time with outer and inner cylindrical surface of the drum.

### SUMMARY OF THE INVENTION

The double acting drum brake engaging at the same time with the outer and inner surface of the drum according to the invention has two pairs of brake shoes, wherein each of both pairs of brake shoes always consists of inner brake shoe with inner brake shoe lining, which is during braking pushed onto the inner drum surface, and outer brake shoe with outer brake shoe lining, which is during braking pushed onto outer drum surface.

The essence of the invention is the fact that a set of levers is connected to each of both brake shoe pairs for pushing the inner brake shoe onto the inner drum and simultaneously pulling of the outer brake shoe to the outer drum surface, wherein the sets of levers of both brake shoe pairs are identical, arranged mirror-inverted opposite each other, wherein each of both sets of levers consists of a first class one lever, whose pivot point is fixedly connected to the stationary part of the braked device, and second class one lever, whose pivot point is also fixedly connected with a stationary part of the braked device, and wherein the end of the longer arm of the first class one lever is connected to the end of the longer arm of the second class one lever using a sliding-pivoting hinge.

The first class one lever is at its shorter arm pivotally connected with the first end of the outer brake shoe, using the first outer pin, positioned spaced from its pivot point, and on the other side from its pivot point than where its first outer pin is, it is pivotally connected with the first end of the inner brake shoe (3) using the first inner pin.

The second class one lever is at its shorter arm pivotally connected with the second end of the outer brake shoe, using the second outer pin, positioned spaced from its pivot point, and on the other side from its pivot point than where its second outer pin is, it is pivotally connected with the second end of the inner brake shoe using the second inner pin.

First class one lever and second class one lever are shaped for creating space for brake cylinder between the sets of levers arranged mirror-inverted opposite each other. For this purpose, the first class one lever could be preferentially at its longer arm in the part between the first inner pin and the end of the longer arm cranked first in the direction of the inner brake shoe and later in the direction from the inner brake shoe. Similarly, the second class one lever could be preferentially at its longer arm in the part between the second inner pin and the end of the longer arm cranked first in the direction of the inner brake shoe and later in the direction from the inner brake shoe.

Brake cylinder fixedly connected to a stationary part of the braked device, which has two actuators extensible in opposite directions for expanding action on the first class one lever of each of both sets of levers always in a place between the first inner pin and the end of the longer arm of the first class one lever, is arranged in the space between the sets of levers arranged mirror-inverted opposite each other and a return spring for mutual pulling together of the second class one levers of both sets of levers, attached always in a place between the second inner pin and the end of the longer arm of the second class one lever is arranged in the space between the sets of levers arranged mirror-inverted opposite each other

One of the advantages of the drum brake with brake shoe lining engaging simultaneously with outer and inner drum surface is that in the cylindrical surface of the drum can be preferentially cut notches for facilitating cooling similarly to the disc brake disc.

The brake according to the invention is preferentially equipped with outer cover in the shape of open cylinder, which is equipped on the inner cylindrical surface with slanting blades for supporting air flow, which during rotation expel air from the internal space of the brake. They thus cool the space and at the same time during the ride prevent the penetration of possible dirt, or water. The effect is increased by bending the edge of the cover near the plate inside, wherein the plate is bend over the edge of the cover with overlap.

Double acting drum brake with brake shoe lining engaging simultaneously with outer and inner drum surface according to the invention combines the advantages of drum brake and disc brake. At the same time, it eliminates the disadvantages of both. It is protected from moisture and soiling with dust and mud. Its effectiveness is comparable to a disc brake, regardless of the drum direction of rotation.

### BRIEF DESCRIPTION OF THE DRAWINGS

Double acting drum brake according to the invention is illustrated in the drawings, where

FIG. 1 represents double acting drum brake according to the invention in section in the plane parallel with rotational axis,

FIG. 2 represents double acting drum brake according to the invention in side view, with brake plate removed, in working position during braking,

FIG. 3 represents double acting drum brake according to the invention in side view, with brake plate removed, in released position,

FIG. 4 represents axonometric view of the brake drum of double acting drum brake according to an exemplary embodiment of the invention,

FIG. 5 represents axonometric view of the cover of double acting drum brake according to an exemplary embodiment of the invention,

FIG. 6 represents exploded view of mutual mounting of individual parts according to an exemplary embodiment of the invention.

### DESCRIPTION OF THE PREFERRED EMBODIMENTS OF THE INVENTION

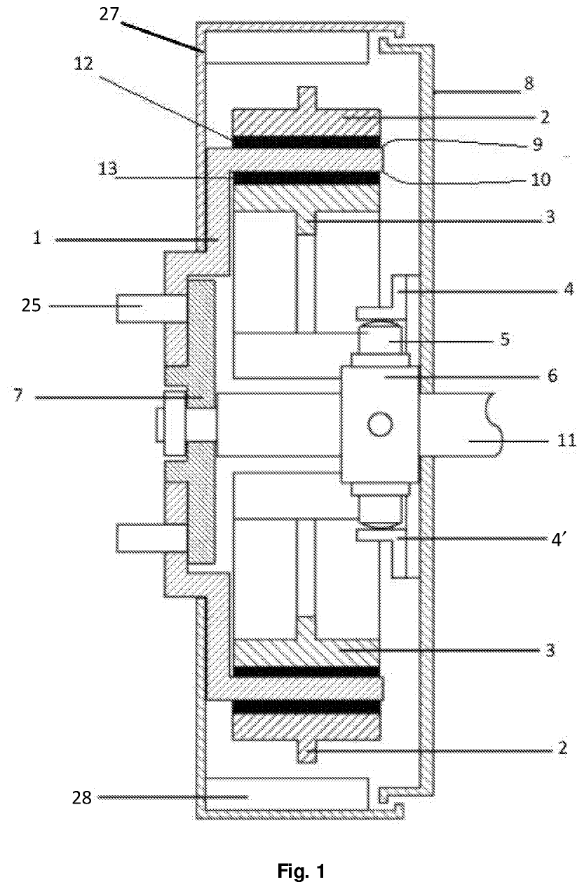

Double acting drum brake according to the example embodiment, represented on FIG. 1 in section parallel with the rotational axis of the device, which should be braked, has a drum 1 in the shape of an open cylinder, whose base is coaxially fixed to the moving part Z of the device, which should be braked. The brake has two pairs of brake shoes, which during braking engage simultaneously always with the outer drum surface 9 and inner drum surface 10. Each of both pairs of brake shoes consists always of inner brake shoe 3, which is using an actuator 5 of the hydraulic piston of brake cylinder 6 via set 4, 4′ of levers during braking pushed onto the inner drum surface 10, and outer brake shoe 2, which is using a set 4, 4′ of levers simultaneously pulled onto the outer drum surface 9. Inner brake shoe 3 carries inner brake shoe lining 13, and outer brake shoe 2 carries outer brake shoe lining 12.

Brake cylinder 6 is screwed to the backing plate 8, which is fixed onto a stable part of the device, which should be braked. Through the backing plate 8 goes shaft 11, which turns and carries the movable part Z of the device, to which is fixedly connected the drum 1, onto which the braked part could be installed, according to the exemplary embodiment e.g. an automobile wheel screwed on using screws 25.

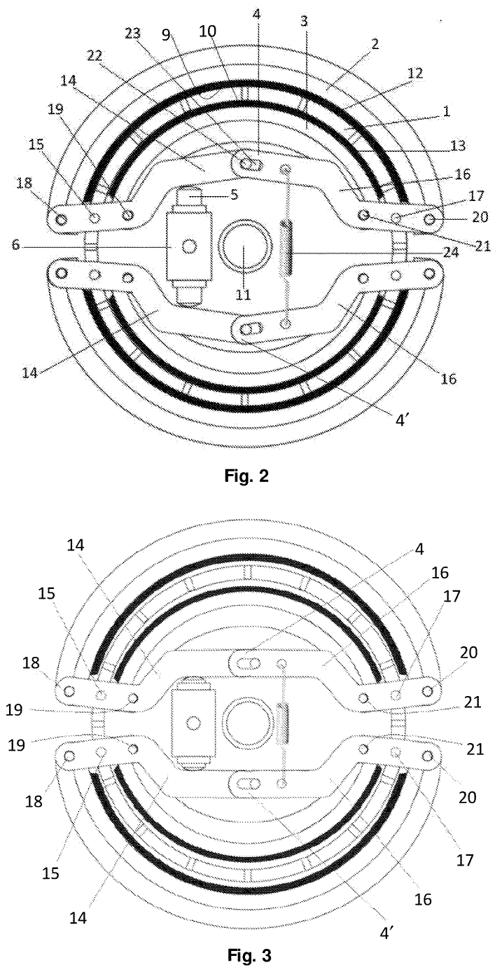

The set 4, 4′ of levers of the respective pair of braking shoes is installed on the backing plate 8, as shown in FIGS. 2 and 3.

Set 4, 4′ of levers of each pair of brake shoes is placed on the side of the backing plate 8 towards drum 1 radially between shaft 11 and inner brake shoe 3 of respective pair of brake shoes. Set 4, 4′ of levers consists of a first class one lever 14, whose pivot point 15 of the first class one lever is fixedly connected with backing plate 8, and second class one lever 16, whose pivot point 17 of the second class one lever is fixedly connected to the backing plate 8 in a distance from the pivot point 15 of the first class one lever, which is smaller than the distance of opposite ends of outer brake shoe 2 and larger than the distance of opposite ends of the inner brake shoe 3.

The first class one lever 14 is at its shorter arm, using first outer pin 18, placed spaced from the pivot point 15 of the first class one lever, pivotally connected with the first end of outer brake shoe 2. The first class one lever 14 has at its longer arm, on the opposite side from the pivot point 15 of the first class one lever than at which is the first outer pin 18, but in the same spacing from it, first inner pin 19, using which it is pivotally connected with the first end of the inner brake shoe 3. The first class one lever 14 is on its longer arm, in the part from the first inner pin 19 to the end of the longer arm cranked twice, and this in the way that it is at first cranked towards the inner brake shoe 3 and then it is cranked in the direction from the inner brake shoe 3, in this example embodiment into the direction generally parallel with its shorter arm.

The second class one lever 16 is at its shorter arm using second outer pin 20, placed spaced from the pivot point 17 of the second class one lever, pivotally connected to the second end of the outer brake shoe 2. Second class one lever 16 has at its longer arm, on the opposite side from the pivot point 17 of the second class one lever than where is the second outer pin 20, but in the same spacing from it, second inner pin 21, using which it is pivotally connected with the second end of inner brake shoe 3. Second class one lever 16 is at its longer arm in the part from the second inner pin 21 to the end of the longer arm, cranked twice, and this in the way that it is at first cranked towards the inner brake shoe 3 and then it is cranked in the direction from the inner brake shoe 3, in this example embodiment into the direction generally parallel with its shorter arm.

First class one lever 14 is at the end of its longer arm connected using a sliding-pivoting hinge with the end of the longer arm of the second class one lever 16. Sliding-pivoting hinge according to the example embodiment consists of a peg 22 at the end of the longer arm of the first class one lever 14, which is engaged in an elongated opening 23 at the end of the longer arm of second class one lever 16.

To the set 4 of levers, which is described above for one pair of brake shoes, at the FIGS. 2 and 3 for the pair of brake shoes illustrated in the upper part of FIG. 2, respective FIG. 3, is a mirror-image symmetric set 4′ of levers, at FIGS. 2 and 3 for the pair of brake shoes illustrated in the lower part of FIG. 2, respective FIG. 3, while both sets 4, 4′ of levers together make an expanding mechanism. Both sets 4, 4′ of levers consist of the same parts, which are denoted by identical reference characters. In the space created by mirroring opposite cranks of the first class one lever 14 of both mirror-image arranged sets 4, 4′ of levers, is placed the brake cylinder 6, screwed to the backing plate 8. Brake cylinder 6 has two actuators 5 that could be extended into opposite directions, acting always on the first class one lever 14 in the place between the crank of the first class one lever 14 and the sliding-pivoting hinge connecting the end of the first class one lever 14 with the end of the second class one lever 16. In the space created by mirroring opposite cranks of the second class one lever 16 of both mirror-image arranged sets 4, 4′ of levers, is placed the return spring 24, acting always on the second class one lever 16 in the place between the crank of the second class one lever 16 and the sliding-pivoting hinge connecting the end of the second class one lever 16 with the end of the first class one lever 14.

The function of the double acting brake according to the invention is clear from the comparison of FIG. 2, which illustrates the drum brake according to the invention in side view and in the working position, and FIG. 3 which illustrates the drum brake according to the invention in side view and in the released, i.e. not-braking position.

In the working position illustrated on FIG. 2 the hydraulic brake cylinder 6 acts via the extended actuator 5 onto the longer arm of the first class one lever 14 of each of both mutually mirror-image arranged sets 4, 4′ of levers, whereby the first class one lever 14 pushes the first inner pin 19 and the inner brake shoe 3 connected with it, to the inner drum surface 10 while simultaneously pulling the first outer pin 18 and the outer brake shoe 2 connected to it to the outer drum surface 9. The first class one lever 14 using the pin 22 at the end of its longer arm at the same time via elongated opening 23 at the end of the longer arm of the second class one lever 16 acts on the longer arm of the second class one lever 16, which simultaneously pushes the second inner pin 21 and the inner brake shoe 3 connected with it to the inner drum surface 10, wherein it simultaneously pulls the second outer pin 20 and the outer brake shoe 2 connected with it to the outer drum surface 9. The outer brake shoe 2, and also the inner brake shoe 3, is thus always, regardless of the direction of rotation of the drum 1, the lead-in and the brake according to the invention is thus double acting.

In the released position illustrated on FIG. 3 the brake cylinder 6 is devoid of pressure and the actuator 5 is retracted. The return spring 24 acts on the longer arm of the second class one lever 16 of each of both mutually mirror-image arranged sets 4, 4′ of levers, whereby the second class one lever 16 pulls the second inner pin 21 ant the inner brake shoe 3 connected with it from the inner drum surface 10, wherein it at the same time pushes the second outer pin 20 and the outer brake shoe 2 connected with it from the outer drum surface 9. in an opposite way to the braking mode, the second class one lever 16 using the end of its longer arm onto the end of the longer arm of the first class one lever 14, which pulls the first inner pin 19 and the inner brake shoe 3 connected with it from the inner drum surface 10, wherein it simultaneously pushes the first outer pin 18 and the outer brake shoe 2 connected with it from the outer drum surface 9.

As illustrated on FIG. 4, the cylindrical surface of drum 1 is in the exemplary embodiment cut through by notches 26 that provide cooling.

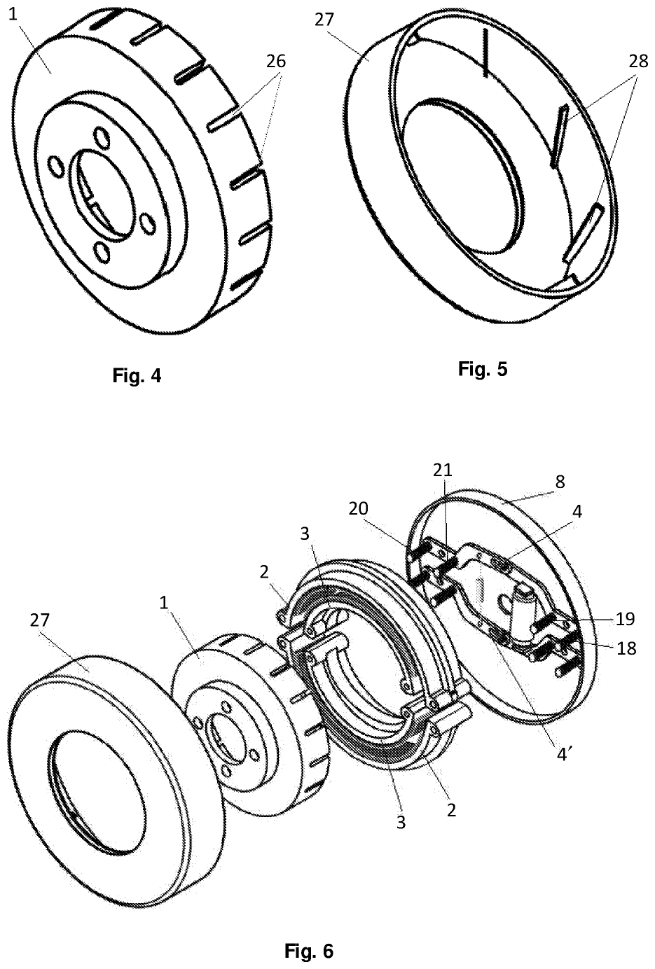

At the same time the whole device is protected from dirt by the outer cover 27, in the shape of an open cylinder, which is at the inner cylindrical surface provided with slanting blades 28, as illustrated on FIG. 5. Slanting blades 28 during rotation expel air from the inner space of the brake, whereby they cool this space and at the same time during the ride prevent the penetration of possible dirt, or water. The protection against dirt ingress is increased by bending the edge of the cover 27 inside, and bending the plate 8 outside, as illustrated on FIG. 1.

Exploded view on FIG. 6 illustrates the mutual setting of individual parts of the brake device according to the exemplary embodiment of the invention.

### LIST OF REFERENCE CHARACTERS

| | |
|---|---|
| 1 | drum |
| 2 | outer brake shoe |
| 3 | inner brake shoe |
| 4, 4′ | set of levers |
| 5 | actuator |
| 6 | brake cylinder |
| 7 | moving part |
| 8 | backing plate |
| 9 | outer drum surface |
| 10 | inner drum surface |
| 11 | shaft |
| 12 | outer brake shoe lining |
| 13 | inner brake shoe lining |
| 14 | first class one lever |
| 15 | first class one lever pivot point |
| 16 | second class one lever |
| 17 | second class one lever pivot point |
| 18 | first outer pin |
| 19 | first inner pin |
| 20 | second outer pin |
| 21 | second inner pin |
| 22 | peg |
| 23 | elongated opening |
| 24 | return spring |
| 25 | screw |
| 26 | notch |
| 27 | cover |
| 28 | slanting blade |

1. A double acting drum brake with brake shoe lining engaging simultaneously with the outer and inner surface of the drum, with two pairs of brake shoes, wherein each of both pairs of brake shoes consists always of inner brake shoe with inner brake shoe lining, which is adapted for engagement with the inner drum surface, and outer brake shoe with outer brake shoe lining, which is adapted for engagement with outer drum surface, wherein
to each of both pairs of brake shoes is, for pushing the inner brake shoe to inner drum surface and simultaneous pulling of outer brake shoe to outer drum surface, connected a set of levers, wherein sets of levers of both pairs of brake shoes are identical, arranged mirroring opposite each other,
wherein each of both sets of levers consists of a first class one lever, whose pivot point of the first class one lever is fixedly connected with a stationary part of braked device, and second class one lever, whose pivot point of the second class one lever is also fixedly connected with a stationary part of braked device, wherein the end of the longer arm of the first class one lever is using a sliding-pivoting hinge connected with the end of the longer arm of the second class one lever,
wherein the first class one lever is at its shorter arm using a first outer pin, located spaced from the pivot point of the first class one lever, pivotally connected with the first end of outer brake shoe, and at the opposite side from the pivot point of the first class one lever, then where the first outer pin is, it is, using a first inner pin, pivotally connected with the first end of the inner brake shoe,
wherein the second class one lever is at its shorter arm using a second outer pin, located spaced from the pivot point of the second class one lever, pivotally connected with the second end of outer brake shoe and at the other side from the pivot point of the second class one lever, then where the second outer pin is, it is, using a second inner pin, pivotally connected to the other end of the inner brake shoes,
wherein in the space between mutually mirroring arranged sets of levers, the brake cylinder is arranged as fixedly connected with stationary part of the braked device, which has two actuators expandable in opposite directions, for expanding acting on the first class one lever of each of both sets of levers always in the place between the first inner pin and the end of the longer arm of the first class one lever, and
wherein in the space between mutually mirroring arranged sets of levers is arranged a return spring for mutual pulling the second class one levers of both sets of levers, attached always in place between the second inner pin and the end of the longer arm of the second first class lever.

2. The double acting drum brake with brake shoe lining engaging simultaneously with the outer and inner surface of the drum according to claim 1, wherein the first class one lever is at its longer arm, in the part between the first inner pin and the end of the longer arm cranked first in the direction towards the inner brake shoe and then in the direction from the inner brake shoe, and the second class one lever is at its longer arm, in the part between the second inner pin and the end of the longer arm cranked first in the direction towards the inner brake shoe and then in the direction from the inner brake shoe.

3. The double-Double acting drum brake with brake shoe lining engaging simultaneously with the outer and inner surface of the drum according to claim 1, wherein the drum is cut through by notches to support cooling.

4. The double acting drum brake with brake shoe lining engaging simultaneously with the outer and inner surface of the drum according to claim 1, wherein it is provided with an outer cover in the shape of open cylinder, which is at the internal cylindrical surface provided with slanting blades, to support air flow.

5. The double acting drum brake with brake shoe lining engaging simultaneously with the outer and inner surface of the drum according to claim 4, wherein the edge of the cover next to the plate is bend inside and the plate is bent outside, overlapping the cover.
